(19) United States
(12) Patent Application Publication
(10) Pub. No.: US 2024/0173828 A1
(43) Pub. Date: May 30, 2024

(54) ELECTRIC TORQUE WRENCH

(71) Applicant: Basso Industry Corp., Taichung (TW)

(72) Inventors: Ta-Chieh Lin, Taichung (TW); San-Yih Su, Taichung (TW)

(73) Assignee: Basso Industry Corp., Taichung (TW)

(21) Appl. No.: 18/513,161

(22) Filed: Nov. 17, 2023

(30) Foreign Application Priority Data
Nov. 24, 2022 (TW) 111212944

(51) Int. Cl. B25B 23/147; B25B 21/00

(52) U.S. Cl. CPC B25B 23/147; B25B 21/004

(57) ABSTRACT

An electric torque wrench includes a ratchet head unit, a wrench body unit, a drive output unit, an electric motor unit, a strain sensor unit, and a control unit. The wrench body unit includes a connection sleeve that is connected to the ratchet head unit. The drive output unit includes a ratchet head driver. The electric motor unit includes an electric motor configured to drive rotation of the ratchet head driver. The strain sensor unit is mounted in the wrench body unit, and is configured to output a torque reading of an external force that acts on the wrench body unit. The control unit includes a display module for displaying the torque reading, a control module signally connected to the electric motor unit, the strain sensor unit, and the display module, and a battery module. The strain sensor unit is located between the electric motor and the battery module.

### CROSS-REFERENCE TO RELATED APPLICATION

This application claims priority to Taiwanese Utility Model Patent Application No. 111212944, filed on Nov. 24, 2022, and incorporated by reference herein in its entirety.

### FIELD

The disclosure relates to an electric torque wrench, and more particularly to an electric torque wrench with torque sensing functionality.

### BACKGROUND

Conventional electric ratchet wrenches are electrically powered tools for tightening or loosening nuts and bolts. They offer the advantage of being electrically powered and are very popular with consumers. However, because the amount of torque that can be outputted by a conventional electric ratchet wrench is limited by the amount of mechanical energy that can be provided by an electric motor of the conventional electric ratchet wrench, consumers often need to use a manual ratchet wrench in conjunction with the conventional electric ratchet wrench.

Additionally, some of the conventional electric ratchet wrenches offer the functionality of a torque wrench which can measure the amount of torque force applied on it. U.S. Pat. No. 10,625,405B2 discloses an example of a powered ratcheting torque wrench. The operating principle of a conventional torque wrench is to use a strain gauge to detect mechanical deformation via a resistivity output. When a user applies a force to tighten a nut or bolt, and thereby deforms the strain gauge, the conventional torque wrench will display a torque reading of the force the user is applying by detecting and converting the change in electric resistivity in the strain gauge.

In order to increase the accuracy of the torque readings, the strain gauge is placed near a head portion of the conventional torque wrench. However, since the strain gauge detects torque force via deformation and the strain gauge is place near the head portion which is the part that contacts the nuts and bolts, collision and vibrations may affect the accuracy of the torque readings and damage the strain gauge. Additionally, the deformability of the strain gauge may weaken the structural integrity of the conventional torque wrench.

### SUMMARY

Therefore, an object of the disclosure is to provide an electric torque wrench that can alleviate at least one of the drawbacks of the prior art.

According to the disclosure, the electric torque wrench includes a ratchet head unit, a wrench body unit, a drive output unit, an electric motor unit, a strain sensor unit, and a control unit. The wrench body unit is connected to the ratchet head unit, has a rear end that is opposite to the ratchet head unit along a first axis, and includes a connection sleeve that is connected to the ratchet head unit. The drive output unit includes a ratchet head driver that is mounted on the ratchet head unit, that extends along a second axis transverse to the first axis, and that is configured to rotate in a selected direction and output rotational energy. The electric motor unit is mounted in the wrench body unit, and includes an electric motor that is configured to drive rotation of the ratchet head driver in the selected direction. The electric motor unit and the rear end cooperatively define an accommodation space that extends along the first axis. The strain sensor unit is mounted in the wrench body unit, extends in the accommodation space, and is configured to output a torque reading of an external force that acts on the wrench body unit. The control unit is mounted in the wrench body unit, and includes a display module, a control module, and a battery module. The display module is for displaying the torque reading outputted by the strain sensor unit. The control module is signally connected to the electric motor unit, the strain sensor unit, and the display module. The battery module is electrically connected to the control module and is for providing electric energy to the electric motor unit and the display module. The strain sensor unit is located between the electric motor and the battery module.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a side view illustrating an embodiment of an electric torque wrench according to the present disclosure.

FIG. 2 is a top view illustrating the embodiment.

FIG. 3 is a cross-sectional view of the embodiment taken along line III-III in FIG. 2.

FIG. 4 is a fragmentary exploded perspective view of the embodiment.

FIG. 5 is a fragmentary partially ghosted perspective view of the embodiment.

FIG. 6 is a fragmentary enlarged cross-sectional view of the embodiment.

FIG. 7 is a fragmentary enlarged cross-sectional view of another embodiment where a connection sleeve and a ratchet head unit are integrally formed in one piece.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

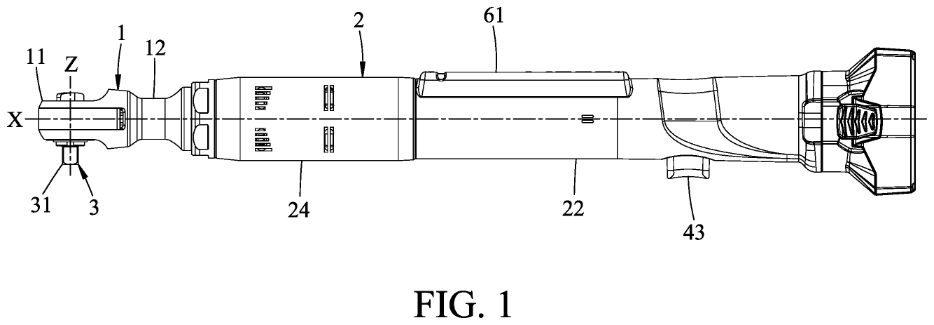

Referring to FIGS. 1 to 3, an embodiment of an electric torque wrench according to the present disclosure includes a ratchet head unit 1, a wrench body unit 2, a drive output unit 3, an electric motor unit 4, a strain sensor unit 5, and a control unit 6.

In this embodiment, the ratchet head unit 1 includes a head portion 11, and a connecting portion 12 that is connected to the head portion 11 and extending along a first axis (X).

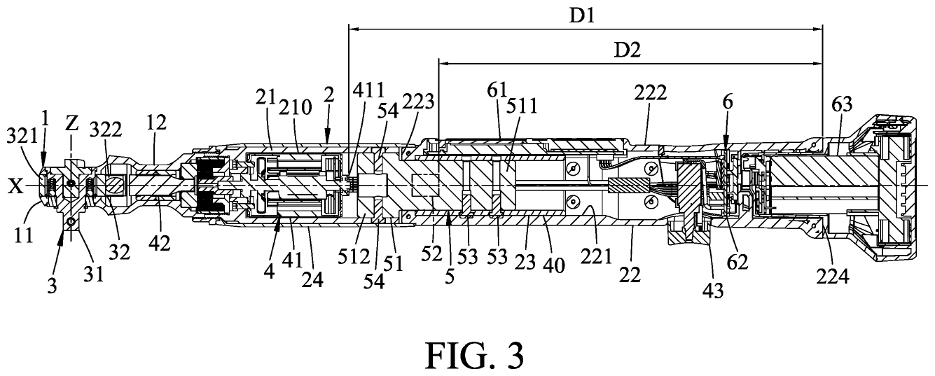

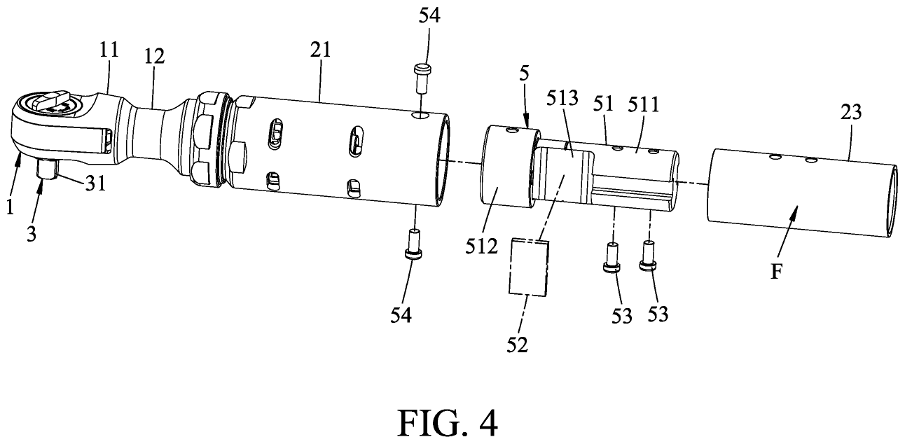

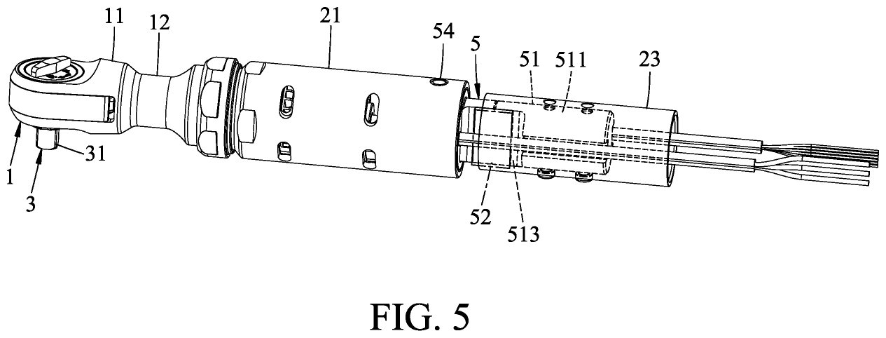

Referring to FIGS. 3 to 5, the wrench body unit 2 surrounds the first axis (X), is connected to the ratchet head unit 1, and includes a connection sleeve 21, a handle 22, a moment arm sleeve 23, and a protection sheath 24.

The connection sleeve 21 is connected to the connecting portion 12 of the ratchet head unit 1, surrounds the first axis (X), and defines an installation space 210.

The handle 22 surrounds the first axis (X) and has an inner surface 221, an outer surface 222 opposite to the inner surface 221, a front end 223 that is proximate to the connection sleeve 21, and a rear end 224 that is opposite to the head portion 11 of the ratchet head unit 1 along the first axis (X).

The moment arm sleeve 23 extends along the first axis (X) inside the handle 22, and contacts the inner surface 221 of the handle 22.

The protection sheath 24 is sleeved on the connection sleeve 21 and the front end 223 of the handle 22, and is disposed between the handle 22 and the ratchet head unit 1 along the first axis (X).

The drive output unit 3 includes a ratchet head driver 31, and a head yoke 32.

The ratchet head driver 31 is mounted on the head portion 11 of the ratchet head unit 1, extends along a second axis (Z) transverse to the first axis (X), and is configured to rotate in a selected direction and output rotational energy.

The head yoke 32 has an annular toothed portion 321 that surrounds the ratchet head unit 31, and a drive tang 322 that extends into the connecting portion 12 and that is configured to be driven by an external force.

It should be noted that the abovementioned drive output unit 3 is well known in the art, and further details of the drive output unit 3 are omitted for the sake of brevity.

The electric motor unit 4 is mounted in the wrench body unit 2. More specifically, the electric motor unit 4 includes an electric motor 41, a transmitting module 42, and a trigger module 43. The electric motor 41 is mounted in the installation space 210 of the connection sleeve 21 for converting electric energy into mechanical power and is configured to drive rotation of the ratchet head driver 31 in the selected direction. The transmitting module 42 is mounted between the ratchet head driver 31 and the electric motor 41 for transmitting mechanical power from the electric motor 41 to the ratchet head driver 31. The trigger module 43 is mounted in the wrench body unit 2 and is operable by a user to activate the electric motor 41.

The electric motor 41 has an end portion 411 that is closest to the rear end 224 of the wrench body unit 2. The end portion 411 of the electric motor 41 and the rear end 224 of the wrench body unit 2 are spaced apart by a first distance (D1) along the first axis (X) (see FIG. 3). The electric motor unit 4 and the rear end 224 cooperatively define an accommodation space 40 that extends along the first axis (X). The moment arm sleeve 23 extends into the accommodation space 40.

The strain sensor unit 5 is mounted in the wrench body unit 2, extends in the accommodation space 40, and includes a strain shaft 51, a strain gauge 52, two first fasteners 53, and two second fasteners 54. The strain shaft 51 extends along the first axis (X) and is in contact with the wrench body unit 2.

The strain shaft 51 and the wrench body unit 2 are configured to receive an external force acting on the wrench body unit 2. The strain shaft 51 has a first end 511 and a second end 512 that are opposite to each other, and that are respectively proximate to and distal from the rear end 224 of the wrench body unit 2. The strain shaft 51 further has a strain detection surface 513 that is formed on the first end 511. The connection sleeve 21 is sleeved on and surrounds the second end 512 of the strain shaft 51 and at least a portion of the electric motor unit 4. The moment arm sleeve 23 is sleeved on the first end 511 of the strain shaft 51 and is sandwiched between the first end 511 and the handle 22.

The strain gauge 52 of the strain sensor unit 5 is connected to the strain detection surface 513 of the strain shaft 51, and is configured for outputting a torque reading of the external force acting on the wrench body unit 2. The strain gauge 52 of the strain sensor unit 5 and the rear end 224 of the wrench body unit 2 are spaced apart by a second distance (D2) along the first axis (X) (see FIG. 3). In this embodiment, the second distance (D2) is less than the first distance (D1), and this ensures that the strain gauge 52 maintains its position in the installation space 40 when operating the electric torque wrench.

The first fasteners 53 are connected to the moment arm sleeve 23 and to the first end 511 of the strain shaft 51, and connects the moment arm sleeve 23 to the first end 511 of the strain shaft 51.

The second fasteners 54 are connected to the connection sleeve 21 and to the second end 512 of the strain shaft 51, and connects the connection sleeve 21 to the second end 512 of the strain shaft 51.

The control unit 6 is mounted in the wrench body unit 2, and includes a display module 61, a control module 62, and a battery module 63. The display module 61 is for displaying the torque reading outputted by the strain sensor unit 5. The control module 62 is signally connected to the electric motor unit 4, the strain sensor unit 5, and the display module 61. The battery module 63 is electrically connected to the control module 62, and is for providing electric energy to the electric motor unit 4 and the display module 61. The strain sensor unit 5 is located between the electric motor 41 and the battery module 63.

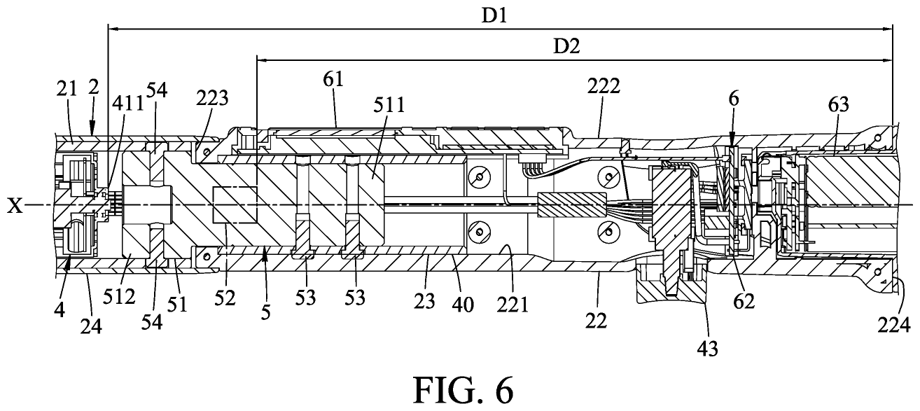

Referring to FIGS. 3, 5, and 6, when the user holds the handle 22 of the wrench body unit 2 and operates the trigger module 43 to activate the electric motor 41, the transmitting module 42 will be powered by the electric motor 41 to transmit mechanical power and drive the drive tang 322 of the head yoke 32 to swing. The swinging of the drive tang 322 will drive the annular toothed portion 321 to rotate the ratchet head portion 31 along the second axis (Z), thereby allowing the electric torque wrench to tighten or loosen a nut/bolt or other type of fastener (all not shown).

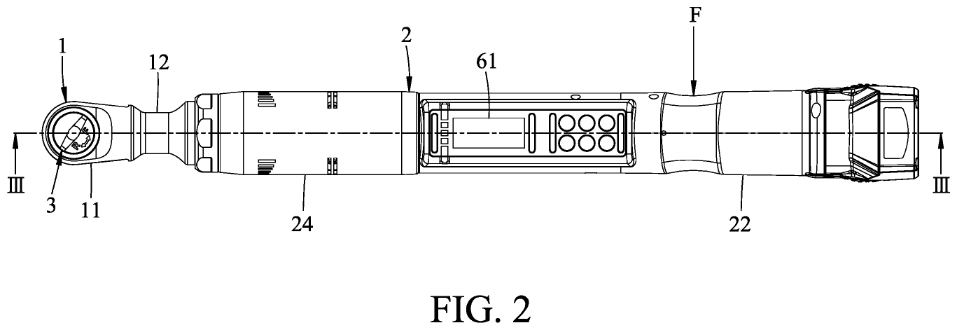

When the user applies an applied force (F) on the handle (see FIG. 2), the wrench body unit 2 and the ratchet head unit 1 serve as a moment arm and the applied force (F) will drive the ratchet head driver 31 to rotate, thereby allowing the user to tighten or loosen nuts/bolts or other type of fasteners manually.

When the user is manually operating the electric torque wrench and applies the applied force (F) on the handle 22, the applied force (F) will be transmitted to the first end 511 of the strain shaft 51, and then to the connection sleeve 21 via the second end 512 of the strain shaft 51, and finally to the ratchet head unit 1 via the connection sleeve 21. It should be noted that, in this embodiment, the strain detection surface 513 is a sensor, and the applied force (F) that is applied to the electric torque wrench will cause the strain detection surface 513 of the strain shaft 5 to deform. The deformation of the strain detection surface 513 is proportional to the amount of applied force (F) that is applied, and will cause a proportional change in electrical resistivity in the strain detection surface 513 which is outputted as a raw data of the applied force (F) acting on the wrench body unit 2.

The control module 62 of the control unit 6 will calculate the raw data outputted by the strain detection surface 513 according to the moment arm of the electric torque wrench and display a torque reading of the applied force (F) on the display module 62.

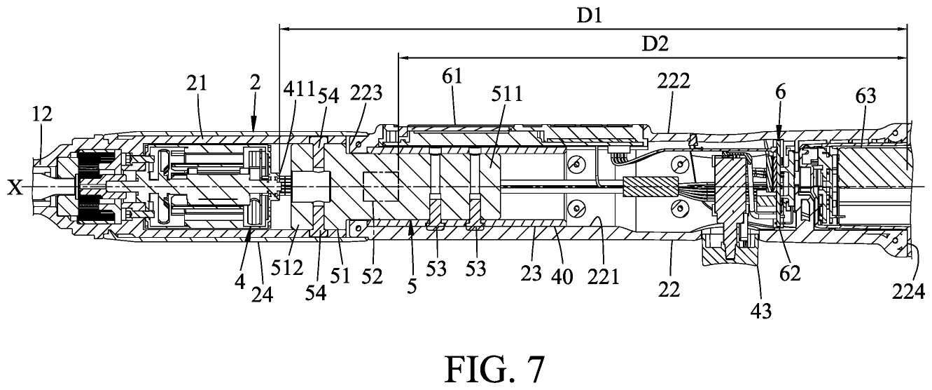

It should be noted that, in some embodiments, as shown in FIG. 7, the connection sleeve 21 and the ratchet head unit 1 are integrally formed in one piece.

In some embodiments, different materials may be used to manufacture the strain shaft 51 of the strain sensor unit 5 to suit different types of applications and improve accuracy of torque readings under specific environments.

By virtue of the connection sleeve 21 and the moment arm sleeve 23 being sleeved on the strain shaft 51, the structural integrity of the electric torque wrench is improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric torque wrench comprising:
a ratchet head unit;
a wrench body unit connected to said ratchet head unit, and having a rear end that is opposite to said ratchet head unit along a first axis;
a drive output unit including a ratchet head driver that is mounted on said ratchet head unit, that extends along a second axis transverse to the first axis, and that is configured to rotate in a selected direction and output rotational energy;
an electric motor unit mounted in said wrench body unit, and including an electric motor that is configured to drive rotation of said ratchet head driver in the selected direction, said electric motor and said rear end cooperatively defining an accommodation space that extends along the first axis;
a strain sensor unit mounted in said wrench body unit, extending in said accommodation space, and configured to output a torque reading of an external force that acts on said wrench body unit; and
a control unit mounted in said wrench body unit, and including a display module that is for displaying the torque reading outputted by said strain sensor unit, a control module that is signally connected to said electric motor unit, said strain sensor unit, and said display module, and a battery module that is electrically connected to said control module, and that is for providing electric energy to said electric motor unit and said display module, said strain sensor unit being located between said electric motor and said battery module.

2. The electric torque wrench as claimed in claim 1, wherein said strain sensor unit includes:
a strain shaft that extends along the first axis, that is in contact with said wrench body unit, and that has a strain detection surface, said strain shaft and said wrench body unit being configured to receive the external force acting on said wrench body unit; and
a strain gauge that is connected to said strain detection surface of said strain shaft, and that is for outputting the torque reading of the external force acting on said wrench body unit.

3. The electric torque wrench as claimed in claim 2, wherein:
said strain shaft further has a first end and a second end that are opposite to each other, and that are respectively proximate to and distal from said rear end of said wrench body unit; and
said wrench body unit includes a handle that surrounds the first axis and that has said rear end, and a moment arm sleeve that is sleeved on said first end of said strain shaft and that is sandwiched between said first end and said handle.

4. The electric torque wrench as claimed in claim 3, wherein said wrench body unit further includes a connection sleeve that is connected to said ratchet head unit, that is sleeved on and that surrounds said second end of said strain shaft and at least a portion of said electric motor unit.

5. The electric torque wrench as claimed in claim 4, wherein said connection sleeve and said ratchet head unit are integrally formed in one piece.

6. The electric torque wrench as claimed in claim 4, wherein said strain sensor unit further includes at least one fastener that connects said moment arm sleeve to said first end of said strain shaft.

7. The electric torque wrench as claimed in claim 4, wherein said strain sensor unit further includes at least one fastener that connects said connection sleeve to said second end of said strain shaft.

8. The electric torque wrench as claimed in claim 4, wherein said wrench body unit further includes a protection sheath that is sleeved on said connection sleeve and that is disposed between said handle and said ratchet head unit along the first axis.

9. The electric torque wrench as claimed in claim 4, wherein:
said electric motor is mounted in said connection sleeve for converting electric energy into mechanical power; and
said electric motor unit further includes a transmitting module mounted between said ratchet head driver and said electric motor for transmitting mechanical power from said electric motor to said ratchet head driver.

10. The electric torque wrench as claimed in claim 9, wherein:
said electric motor has an end portion that is closest to said rear end of said wrench body unit; and
said end portion of said electric motor and said rear end of said wrench body unit are spaced apart by a first distance along the first axis.

11. The electric torque wrench as claimed in claim 10, wherein:
said strain detection surface of said strain shaft is formed on said first end of said strain shaft;
said strain gauge of said strain sensor unit and said rear end of said wrench body unit are spaced apart by a second distance along the first axis; and
said second distance is less than said first distance.
